(19) United States
(12) Patent Application Publication
(10) Pub. No.: US 2009/0187528 A1
(43) Pub. Date: Jul. 23, 2009

(54) METHOD AND SYSTEM FOR ASSESSING RISK

(76) Inventors: Robert Craig Morrell, Powder Springs, GA (US); Michael Daniel Ulveling, Marietta, GA (US); Antonio Dabraio, Atlanta, GA (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 12/356,460

(22) Filed: Jan. 20, 2009

Related U.S. Application Data
(60) Provisional application No. 61/021,863, filed on Jan. 17, 2008.

(51) Int. Cl. G06N 5/02

(52) U.S. Cl. 706/52

(57) ABSTRACT

A system and method for assessing a risk outcome that is affected by other risks. The risks and risk outcome are identified, and a relationship among the risks are defined where all of the risks directly or indirectly influence the risk outcome. An influence of each risk on at least one of the other risks or the risk outcome is defined. A portion of the risk relationship hierarchy and a subset of the risks is displayed graphically.

### CLAIM OF PRIORITY

The present application claims the benefit of the U.S. provisional patent application filed on Jan. 17, 2008 by Robert Morrell et al for METHOD AND SYSTEM FOR ACCESSING RISK (Ser. No. 61/021,863), the entire disclosure of which is incorporated by reference as if set forth verbatim herein.

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright whatsoever.

### FIELD OF THE INVENTION

The present invention relates generally to risk assessment. More particularly, the present invention relates to a method and system for assessing the cumulative influence of various risks on other risks and on risk outcomes.

### BACKGROUND OF THE INVENTION

Most decisions involve an assessment of the frequency and/or influence of one or more risks related to the decision. Each risk that may have an effect on a decision may be influenced by various additional sub-risks. Additionally, a sub-risk may have both an indirect influence on a decision, due to its effect on another risk, and a direct influence on the decision itself. Businesses attempt to manage the risks that may potentially affect the business.

### SUMMARY OF THE INVENTION

The present invention recognizes and addresses the foregoing considerations, and others, of prior art construction and methods.

The present invention is directed to a method and system for assessing risk. In this regard, one embodiment of the present invention allows a user to define and analyze the influence of various risks on all or on part of a business.

According to another aspect, the present invention also provides a computerized method for assessing a risk outcome that is affected by other risks, the method comprising the steps of identifying a plurality of risks and a risk outcome, defining a relationship hierarchy among the plurality of risks and the risk outcome, where all the risks of the plurality of risks directly or indirectly influence the risk outcome, comprising defining an influence of each risk on at least one other of the plurality of risks or the risk outcome, and graphically displaying at least a portion of the relationship hierarchy, comprising graphically displaying a subset of the plurality of risks.

A further aspect of the present invention provides a computerized method for assessing a risk outcome that is affected by other risks, the method comprising the steps of identifying a plurality of risks and a risk outcome, defining a relationship hierarchy among the plurality of risks and the risk outcome, wherein all the risks of the plurality of risks directly or indirectly influence the risk outcome, comprising defining a direct influence of each risk on at least one other said risk or the risk outcome, determining a cumulative influence of each first risk of the plurality of risks on the risk outcome as a function of the influences defined between the first risk and the risk outcome, and graphically displaying a selectable group of the plurality of risks and the risk outcome, including a respective indicator for each graphically displayed risk that represents the cumulative influence of the graphically displayed risk on the risk outcome.

In another aspect, there is provided a device for assessing a risk outcome that is affected by other risks comprising a computer readable medium comprising program instructions and a processor operatively connected to the computer readable medium, wherein the processor is configured to execute the program instructions to perform a method comprising the steps of identifying a plurality of risks and a risk outcome, defining a relationship hierarchy among the plurality of risks and the risk outcome, wherein all the risks of the plurality of risks directly or indirectly influence the risk outcome, comprising defining a direct influence of each risk on at least one other said risk or the risk outcome, determining a cumulative influence of each first risk of the plurality of risks on the risk outcome as a function of the direct influences defined between the first risk and the risk outcome, and graphically displaying a selectable group of the plurality of risks and the risk outcome, including a respective indicator for each graphically displayed risk that represents the cumulative influence of the graphically displayed risk on the risk outcome.

### BRIEF DESCRIPTION OF THE DRAWINGS

The accompanying drawings, which are incorporated in and constitute a part of this specification, illustrate one or more embodiments of the invention and, together with the description, serve to explain the principles of the invention. A full and enabling disclosure of the present invention, including the best mode thereof directed to one of ordinary skill in the art, is set forth in the specification, which makes reference to the appended drawings, in which:

FIG. 1 is a schematic representation of a system for assessing risk in accordance with an embodiment of the present invention;

FIG. 2 is a schematic representation of a relational database for assessing risk in accordance with an embodiment of the present invention;

FIGS. 3A and 3B are graphic representations of a risk profile in accordance with an embodiment of the present invention;

FIG. 4 is a flowchart of a process for creating a set of relevant risks in accordance with an embodiment of the present invention;

FIGS. 5A and 5B are graphic representations of sets of relevant risks in accordance with an embodiment of the present invention;

FIGS. 6 and 7 are flowcharts of processes for creating a cumulative influence graph for a set of relevant risks in accordance with an embodiment of the present invention;

FIG. 8 is an exemplary cumulative influence graph created by the processes of FIGS. 6 and 7 in accordance with an embodiment of the present invention;

FIG. 9 is an exemplary graphical user interface of an exemplary cumulative influence graph in accordance with an embodiment of the present invention;

FIGS. 10 and 11 are flowcharts of processes for creating a cumulative influencer graph for a set of relevant risks in accordance with an embodiment of the present invention;

FIG. 12 is an exemplary cumulative influencer graph created by the processes of FIGS. 10 and 11 in accordance with an embodiment of the present invention;

FIG. 13 is an exemplary graphical user interface of an exemplary cumulative influencer graph for a set of relevant risks in accordance with an embodiment of the present invention; and

FIG. 14 is an exemplary graphical user interface of a risk profile in accordance with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

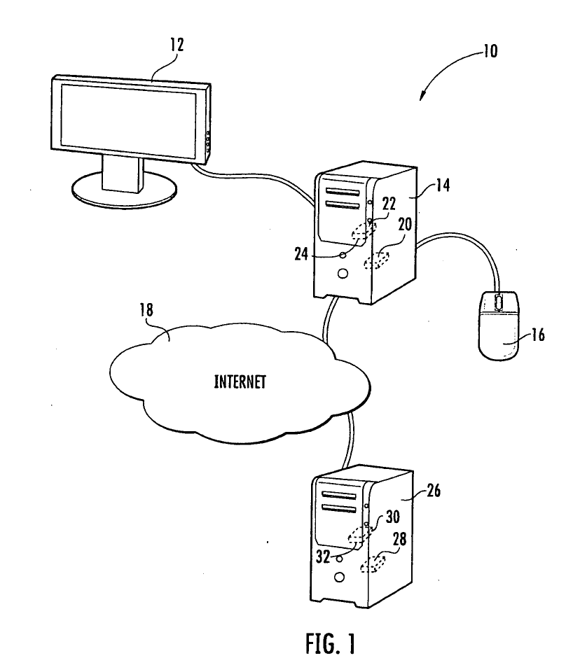

FIG. 1 illustrates a system 10 for assessing risk in accordance with an embodiment of the present invention. Referring to FIG. 1, system 10 includes a display 12, a computer 14, and an input device, such as a mouse 16 or a keyboard. Computer 14 may be connected to a local or distributed network, such as the Internet 18, and comprises a processing device 20 and computer readable memory 22, which contains at least one database 24. It should be understood that computer readable memory can be, for example, random access memory, a hard drive, a flash drive, a CD-ROM, a DVD, or a combination thereof. System 10 may also include additional computers connected to the Internet 18, such as server 26, which includes its own processing device 28 and computer readable memory 30 that may include one or more additional databases 32. In the presently-described embodiment, a program or program code is stored on computer readable memory 22 such that, when executed by processing device 20, performs the processes described below. In another embodiment, a portion of the program or program code is stored on computer readable memory 30 such that, when executed by processing device 28, performs a portion of the processes described below.

In a preferred embodiment, a backend portion of the program described above is created on the force.com platform and written in the APEX programming language, both of which are provided by salesforce.com. The system interacts with a database through the use of SOQL, the platform's structured query language. The frontend graphical user interfaces (“GUIs”) are displayed using an internet or web browser and are created using dynamic HTML, JAVASCRIPT, and ADOBE FLASH. Portions of the user interfaces are created using the DOJO JAVASCRIPT library, as well as the FLASH ACTIONSCRIPT scripting language. It should be understood by one of ordinary skill in the relevant art from the below explanation that the system or portions of the system may be created using any programming languages, tools, or platforms depending on the desired goals and requirements of the specific system without departing from the scope and spirit of the present invention.

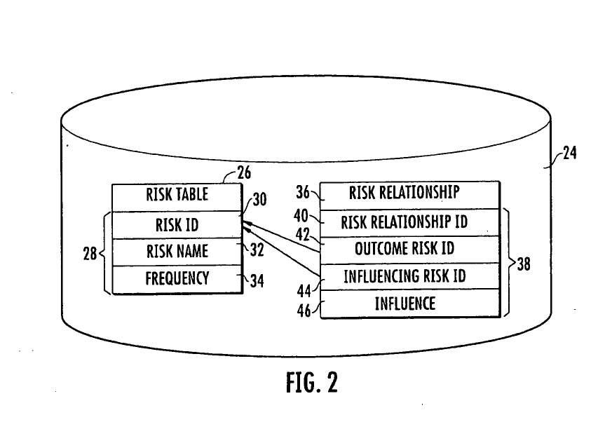

Risks can generally be characterized as having a frequency at which the risk is likely to occur. In the presently-described embodiment, this frequency is measured as the likelihood the risk might occur in a given year; i.e., the annual likelihood. For example, Risk A in the table below has a 50% likelihood it will occur in a year. FIG. 2 illustrates database 24 in accordance with an embodiment of the present invention. Referring to FIG. 2, database 24 includes a Risk Table 26 containing multiple records 28. Each record 28 includes a unique risk identification (“id”) 30, a risk name 32, and a frequency 34 associated with a risk. An example of such a table is set forth as Table 1 below:

| Risk ID | Risk Name | Risk Frequency |
|---|---|---|
| 1 | A | 50% |
| 2 | B | 50% |
| 3 | C | 25% |
| 4 | D | 75% |

Risk id 30 functions as the primary key for Risk Table 26, while a descriptive label for each risk is stored in risk name 32. Frequency 34 stores the likelihood the associated risk will occur in a given time frame. For the discussion below, the frequency of each risk is identified as a percentage representing the likelihood the associated risk will occur in a given year; i.e., the annual likelihood.

The occurrence of one risk will have an influence on at least one other risk or outcome. For the discussion below, the affected risk or outcome, such as an interruption in the relevant business or product availability, is referred to as the risk outcome. The influence the first risk would exert on the risk outcome should the first risk occur may be measured as a percentage that indicates the extent to which the risk outcome will occur or be affected due to the occurrence of the first risk. Thus, a 100% influence indicates the first risk has a complete influence on the risk outcome and, thus, the risk outcome will occur if the first risk occurs. In the below example, Risk B has a 50% influence on Risk A, indicating that half of the risk outcome represented by Risk A will take place if Risk B occurs.

Referring again to FIG. 2, database 24 includes a Risk Relationship Table 36 containing multiple records 38. Each record 38 includes a unique risk relationship id 40, an outcome risk id 42, an influencing risk id 44, and an influence 46. The outcome risk id 42 correlates to risk id 30 of Risk Table 26 and indicates which risk of the corresponding risk relationship is being influenced. Influencing risk id 44 also correlates to risk id 30 of Risk Table 26 and indicates which risk of the corresponding risk relationship would cause an influence should it occur, the extent of which is the value of influence 46 for the corresponding relationship. An example of such a table is set forth as Table 2 below:

| Relationship ID | Outcome Risk ID | Influencing Risk ID | Influence |
|---|---|---|---|
| 1 | 1 | 2 | 50% |
| 2 | 2 | 3 | 25% |
| 3 | 1 | 3 | 25% |
| 4 | 2 | 4 | 10% |

The above exemplary table indicates that Risk B has a 50% direct influence on Risk A, while Risk C has a 25% direct influence on both Risks A and B. As described below, Risk C also indirectly influences Risk A because it directly influences Risk B. Risk D has a direct influence on Risk B only at 10%, but also indirectly influences Risk A due to its direct influence on Risk B. Any risk or event that has an influence on the overall performance or operation of a business, on any portion of the business, or on any other risk may be added to the tables described above, thereby allowing a user to analyze the cumulative influence of the relevant risk through the processes described below. Thus, the Risk Relationship Table 36 contains a relationship hierarchy in which each risk is related to another other risk that it either directly influences or is influenced by.

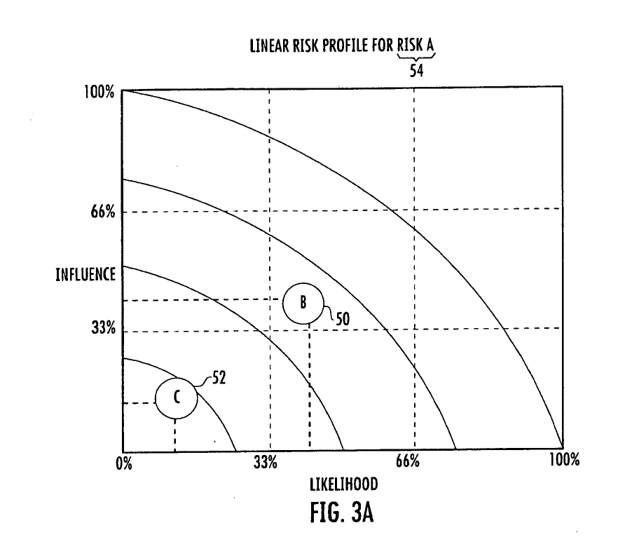

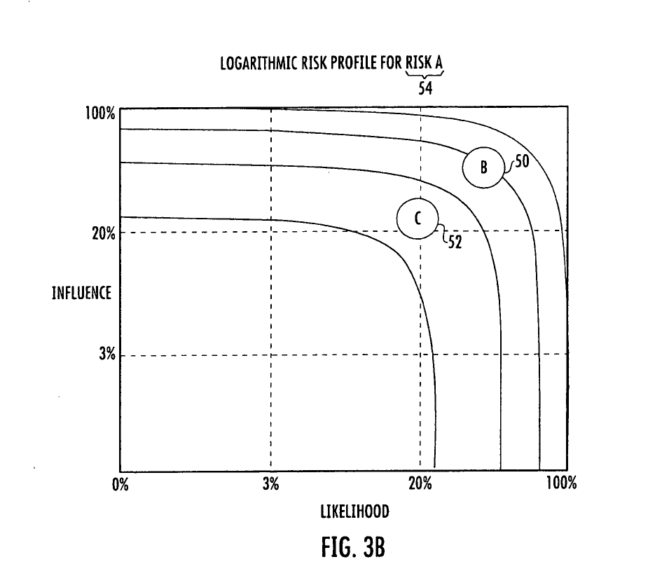

The risk relationships where a risk or risk outcome is the influenced risk may be graphically depicted, such that the frequency of each risk directly influencing the selected risk outcome provides a coordinate relative to an axis on the graph for the risk, while the direct influence each risk exerts on the risk outcome should the risk occur provides the additional coordinate for the risk relative to the other axis of the graph. Using the data from Table 2 above, for example, FIG. 3A illustrates the annual likelihood of influencing risks B and C, denoted at 50 and 52, respectively, along with the influence each risk exerts on Risk A, i.e., the risk outcome in this example (denoted at 54). Referring to FIG. 3A, the y-axis represents the influence exerted by each risk that directly influences the risk outcome, while the x-axis represents the likelihood that each influencing risk will occur.

FIG. 3A illustrates the frequency and influence of each graphically depicted risk on a linear scale. That is, the distance between each unit of measurement on the y and x axes is uniformly separated. FIG. 3B illustrates the annual likelihood of Risk B (50) and Risk C (52) and their respective influences on Risk A (54) on a logarithmic scale. That is, the unit of measurement on the y and x axes are not uniformly spaced apart, but are instead separated on a logarithmic scale. A logarithmic scale in the present invention allows risks located within the same general area of the graph to be spread out in order to allow for a more accurate placement and analysis of the displayed risks. Although both the y and x axes in FIG. 3B are on a logarithmic scale, it should be understood that either axis within a graph depicting the characteristics of the risks that directly influence the risk outcome can be independently selected to be displayed linearly or logarithmically. In one embodiment, the graphs described above are created by processing device 20 and/or 28 and displayed on display 12.

As shown in the example above, an influencing risk may have a direct influence on multiple other outcome risks. Additionally, an outcome risk may be affected by a number of influencing risks which may, in turn, be affected by a number of other influencing risks. Also, a risk may be both an influencing risk, thereby having an influence on one or more other risks, as well as an outcome risk, which is affected by one or more influencing risks. It should therefore be understood that the present invention encompasses the ability to handle numerous risks, which may be characterized by a set or table of complex relationships. A user is able to define an unlimited number of risks and relationships among these risks.

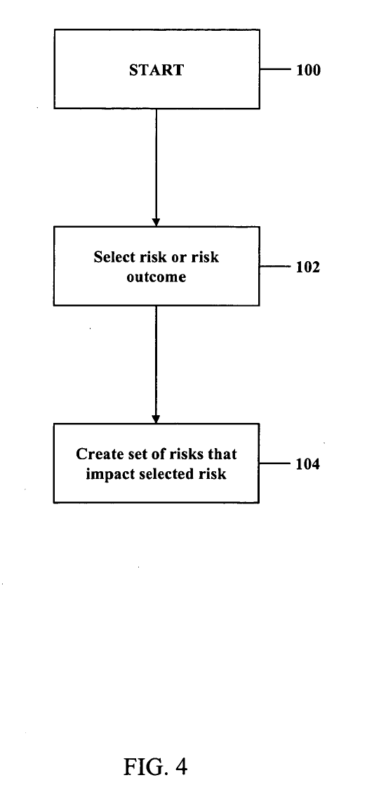

A specific risk or risk outcome can be selected in order to analyze the cumulative influence of all other risks that have a direct or indirect influence on the selected risk. For the explanation that follows, the selected risk or risk outcome will be referred to as the “selected risk” because it will be the risk or risk outcome that is currently being analyzed. Referring to FIG. 4, the process begins at block 100. In order to analyze which risks have an influence on the selected risk, either directly or indirectly, as well as the significance of each cumulative influence, a selected risk is chosen at block 102. In one embodiment, system 10 (FIG. 1) displays the risks contained in Risk Table 26 (FIG. 2) on display 12 (FIG. 1) in order to allow a user to choose one of the risks with an input device, such as mouse 16 (FIG. 1), thereby identifying the risk as the selected risk. In the presently-described embodiment, a breadth-first-search (“BFS”) is then performed on the relationship table described above in order to retrieve a set of all relevant relationships, which includes all risks that directly or indirectly influence the selected risk at block 104. In this way, the BFS adds all risks from the relationship table that have a direct influence on the selected risk. The BFS then adds to the set all risks from the risk relationship table that have a direct influence on the risks already in the set, but does not add duplicate instances of risks already in the set. The set also includes an identification of all relationships between the risks that have been added to the set. The BFS continues in this manner until all risks that directly influence any other risk in the set have been added to the set. Accordingly, the final set includes all risks that directly or indirectly influence the selected risk.

In another embodiment, a depth-first-search (“DFS”) may be used to retrieve a set of all the relevant risks. It should be understood that the set created by a DFS should be identical to the set created by a BFS for the present invention. BFS and DFS searches should be understood by those of ordinary skill in the art and are, therefore, not described in more detail herein. As an example, the set resulting from a BFS or a DFS performed on the data contained in the above exemplary Tables 1 and 2, if Risk A is the selected risk, includes all the relationships and risks contained in the two tables because each risk contained therein either directly or indirectly influences Risk A. As noted above, the set also includes an identification of each relationship among the risks included in the set.

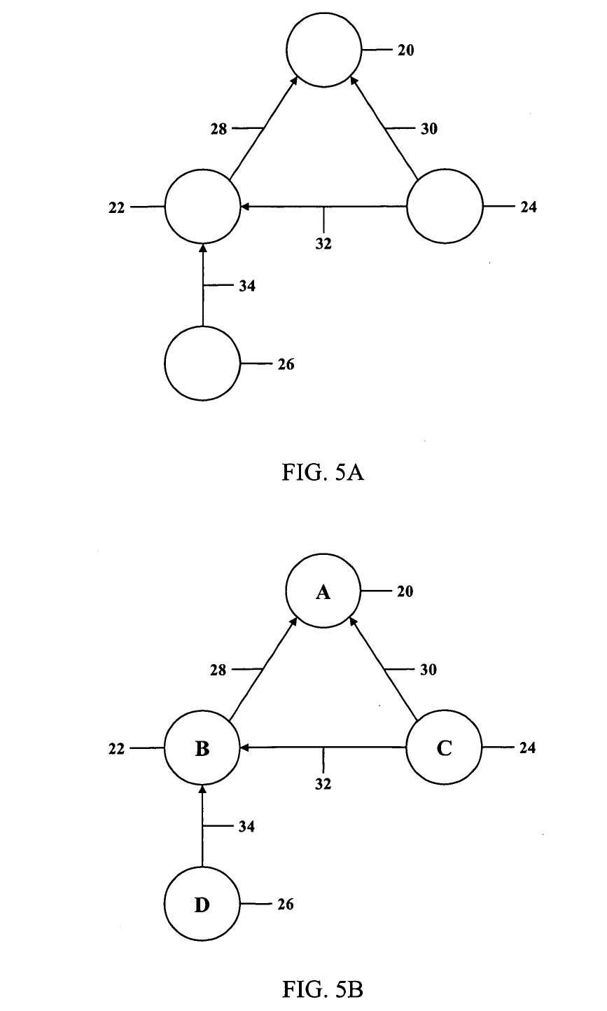

The set resulting from the process described above may be depicted as a graphical representation, such as the graph shown in FIG. 5A. FIG. 5A depicts a graph that illustrates multiple risks 20, 22, 24, and 26 characterized by relationships 28, 30, 32, and 34. Referring to FIG. 3, a selected risk 20 is influenced by both risks 22 and 24 as indicated by relationships 28 and 30, respectively. Additionally, risk 22 is influenced by risks 24 and 26 as indicated by respective relationships 32 and 34. A graph illustrating the relationship of all risks that directly or indirectly a selected risk, such as the graph depicted in FIG. 5A, allows a user to graphically analyze a specific risk and the risks that influence the selected risk. For example, a user may select the overall performance or operation of a business as the specific risk outcome to be analyzed. The resulting graph includes all risks that have a direct or indirect influence on the business, thereby allowing the user to quickly examine all the risks that could affect the operation of the business. FIG. 5B depicts a relationship graph identical to the one set forth in FIG. 5A, but applying the data contained in the above exemplary Tables 1 and 2.

In another embodiment of the present invention, the relationship path between a selected risk and each risk, which has been included in a set containing all risks that exhibit a direct or indirect influence on the selected risk, can be characterized as having a relationship depth. The relationship depth correlates to how directly the selected risk is influenced by the risk to which the relationship depth corresponds. For example, a relationship depth of 1 is associated to the risks that directly influence the selected risk, whereas a relationship depth of 2 relative to the selected risk is associated to the risks that directly influence the risks having a relationship depth of 1. Accordingly, each risk that influences, either directly or indirectly, the selected risk can be associated with a relationship depth relative to the selected risk.

In another embodiment, a user may select a maximum relationship depth in order to limit the risks that are included in the user's analysis of the selected risk. As a result, the relationship graph displaying the risks within a set created by the BFS or DFS is limited to the risks in the set that are associated with a relationship depth relative to the selected risk that is less than or equal to the chosen maximum relationship depth. For example and with reference to FIG. 5A, if a user sets the maximum relationship depth equal to 1, the ensuing graph would include selected risk 20, risks 22 and 24, and relationships 28, 30, and 32, but would exclude risk 26 and relationship 34 because risk 26 has a relationship depth of 2 relative to the selected risk.

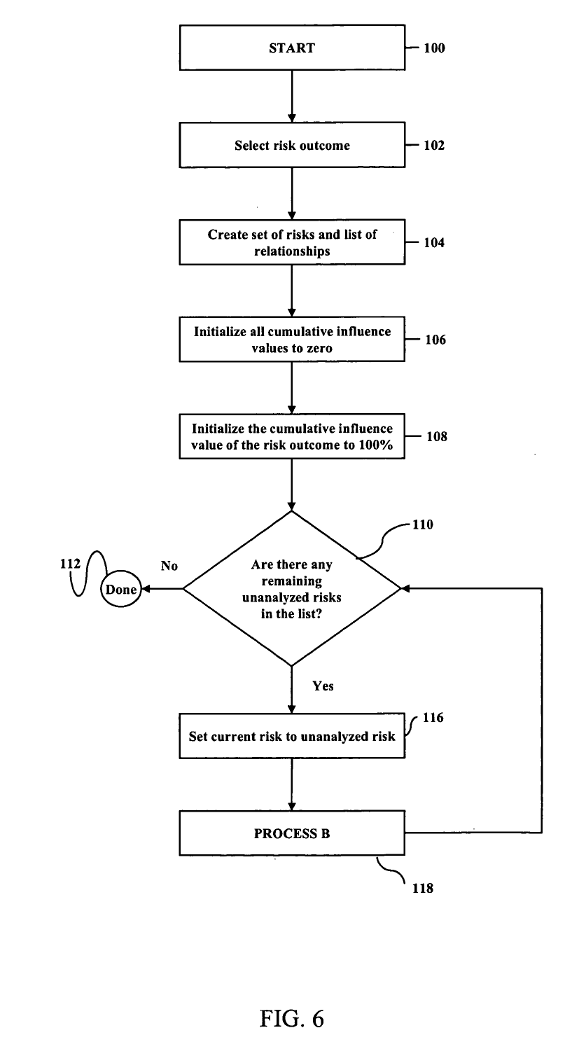

In yet another embodiment, a cumulative influence value can be assigned to each risk within a set that directly or indirectly influences the selected risk. The cumulative influence value indicates the overall effect the risk will have on the selected risk should the risk occur. The process for calculating the cumulative influence value of each risk in a set is described below with reference to FIG. 6 and begins once a risk outcome has been selected, as shown at block 102. At block 104, a set of risks that influence the selected risk, either directly or indirectly, is created by a BFS or a DFS as described above. The set includes an identification of all the relationships among the risks within the set. At block 106, the cumulative influence value for each risk within the set is initialized to zero. A cumulative influence value of 100% is assigned to the risk outcome at block 108, and the risk outcome is marked as analyzed. It should be understood that a cumulative influence value of 100% indicates that the occurrence of the associated risk would cause the risk outcome to occur. Thus, a value of 100% is assigned to the selected risk because its occurrence would completely affect itself.

Once a risk, such as the risk outcome, has been assigned a cumulative influence value, the cumulative influence values for the risks that influence the selected risk can be calculated. For the convenience of the following explanation, each risk whose cumulative influence value has been calculated is referred to as the “valued risk,” while the risk for which the cumulative influence value is currently being calculated is referred to as the “current risk.”

At decision block 110, the determination is made whether the risk set created at block 104 contains any unanalyzed risks. Whether a risk within the set has been marked as analyzed is described in more detail below. If the risk set does not include any more unanalyzed risks, the process is complete at block 112. If the risk set does contain at least one unanalyzed risk, however, process flow continues to block 116 where the “current risk” is set to any unanalyzed risk in the risk set. At block 118, the current risk is then provided as an “input risk” to Process B.

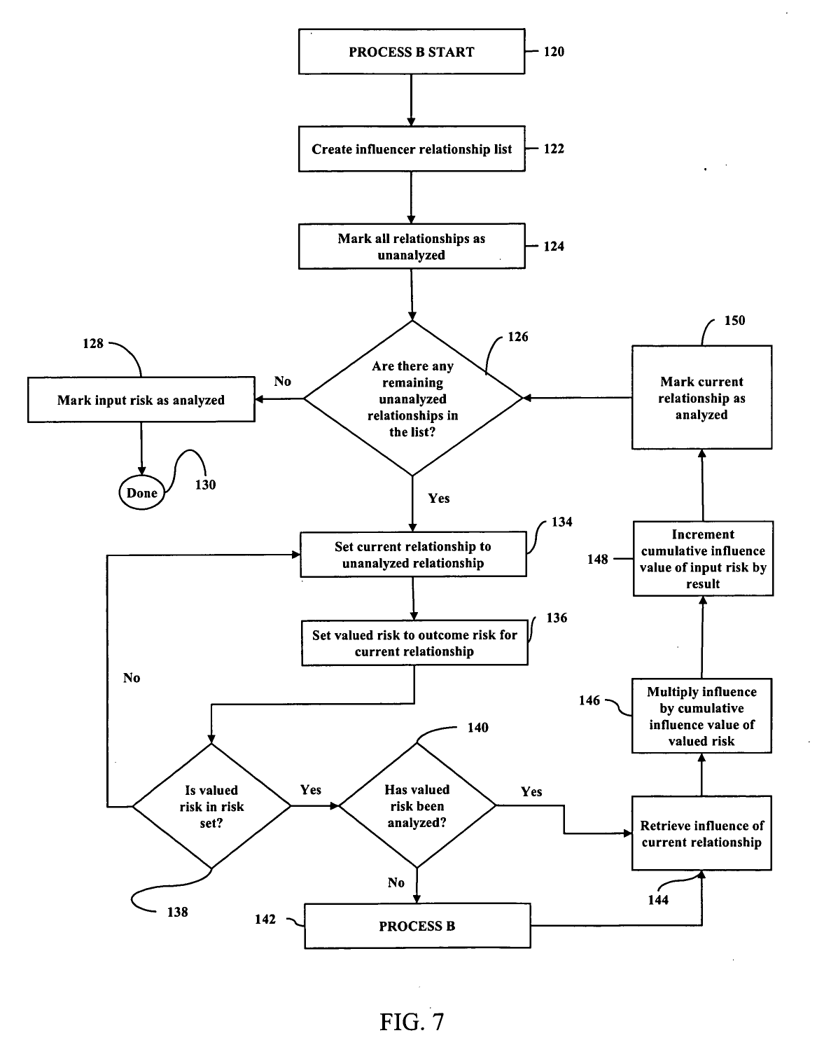

Referring to FIG. 7, Process B begins at block 120, and at block 122, a list of relationships is created from the set where the input risk influences another risk or risk outcome. In other words, the list includes relationships where the input risk is the influencing risk in the Risk Relationship table 36 (FIG. 2) where the outcome risk is included in the set. Each relationship in the list created at block 122 is marked as unanalyzed at block 124. At decision block 126, the determination is made whether there are any unanalyzed relationships in the list created at block 122. If not, process flow continues to block 128, where the input risk is marked as analyzed, and then on to block 130, where Process B terminates. In this situation, process flow returns to block 118 (FIG. 6) and on to decision block 110 where the process continues as described above.

If there are any remaining unanalyzed relationships, however, process flow continues to block 134 where the “current relationship” is set to any unanalyzed relationship in the relationship list created at block 122. At block 136, the “valued risk” is set to the outcome risk of the current relationship. At decision block 138, the determination is made whether the valued risk is in the set created at block 104 (FIG. 6), meaning that the valued risk has an influence on the risk outcome. If the valued risk is not in the set, the corresponding relationship is marked as analyzed, and process flow returns to block 134, where the current relationship is set to the next unanalyzed relationship. If the valued risk is in the set created at block 104 (FIG. 6), the determination is then made whether the valued risk has been analyzed at decision block 140. If it has not, the valued risk is then provided as an input risk to Process B at block 142. Thus, it should be understood that the described process is recursive in nature, and the subroutine referred to as “Process B” may be recursively executed. Process B for the new input risk begins at block 120 and flows as described above. Upon completion of the recursive process B, process flow continues to block 144 and continues as described below.

If the determination is made at block 140 that the valued risk has been analyzed, process flow continues to block 144. The influence of the current relationship is retrieved from the set at block 144 and multiplied by the cumulative influence value of the valued risk at block 146. The result is added to the cumulative influence value of the input risk at block 148. At block 150, the list of relationships created at block 122 is updated to indicate the current relationship has been analyzed. Process flow then returns to decision block 126 and continues as described above.

It should be understood that the above process may yield a cumulative influence value that is greater than 100% for a given risk, thereby indicating that the given risk may have very a significant influence on the selected risk. In the presently-described embodiment, a value greater than 100% is reduced to 100% because a given risk generally cannot exhibit greater than a full influence on the selected risk. It should be apparent, however, that a value greater than 100% can be associated with a given risk to show the significance of the cumulative influence of the given risk on the selected risk depending on the goals and requirements of the current user or system. Likewise, risks that are associated with a cumulative influence value less than a predefined amount, such as 0% or 5% for example, may be excluded from the analysis by the system at the request of the user.

For example, an epidemic, such as Avian Flu, while rare, may influence almost every other risk or risk outcome for a business, such as an interruption in shipping, production, management, etc., if it were to occur. Depending on the size of the influence that the epidemic exhibits on each of the risks or risk outcomes that it directly influences, a cumulative influence value greater than 100% may be assigned to the risk associated with the epidemic. This would indicate that the occurrence of the epidemic would have a very significant cumulative influence on the selected risk or risk outcome, such as the overall operation or performance of the business.

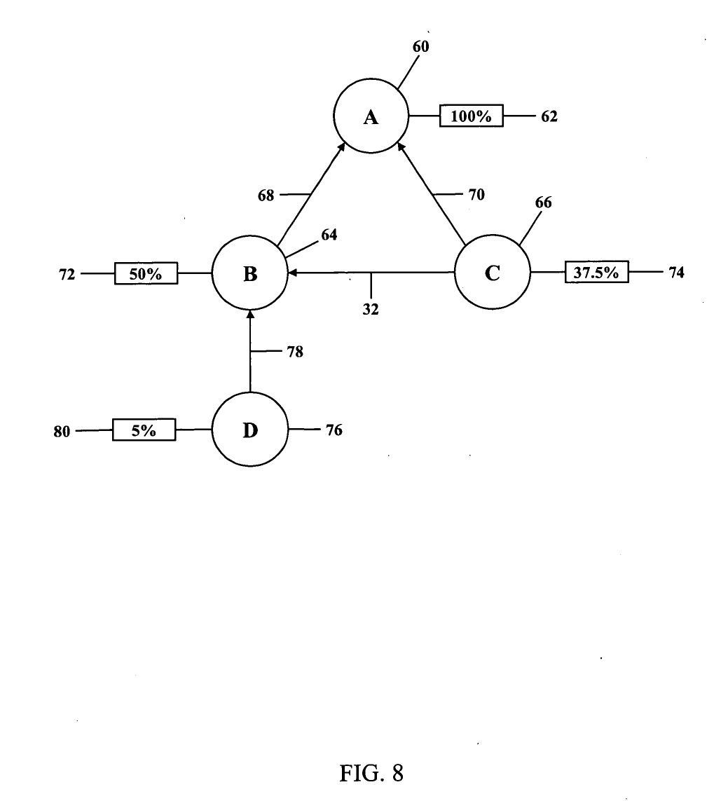

In another embodiment of the present invention, the risks within a set, the relationships interconnecting the risks, and the cumulative influence value of each risk may be graphically displayed once the process described above with respect to FIGS. 6 and 7 has been performed for the set of risks created with respect to the selected risk. FIG. 8 depicts such a graph that is based on the data set forth above in exemplary Tables 1 and 2. Referring to FIG. 8, a node 60 is the selected risk or risk outcome, which is Risk A in the current example. Risk A is associated with a cumulative influence value of 100%, denoted at 62. Risk A is influenced by Risk B (at 64) and Risk C (at 66) as indicated by relationships 68 and 70, respectively. Risk B is associated with a cumulative influence value of 50%, denoted at 72, while Risk C is associated with a cumulative influence value of 37.5%, denoted at 74. Risk B is influenced by another risk 76, Risk D, as indicated by relationship 78. Risk D is associated with a cumulative influence value of 5%, denoted at 80, thereby indicating that the occurrence of Risk D will have a 5% effect on selected risk 40, ie., Risk A. Although FIGS. 5A, 5B, and 8 represent exemplary graphs in two dimensions, it should be understood that the risks within a given set may be illustrated in three dimensions.

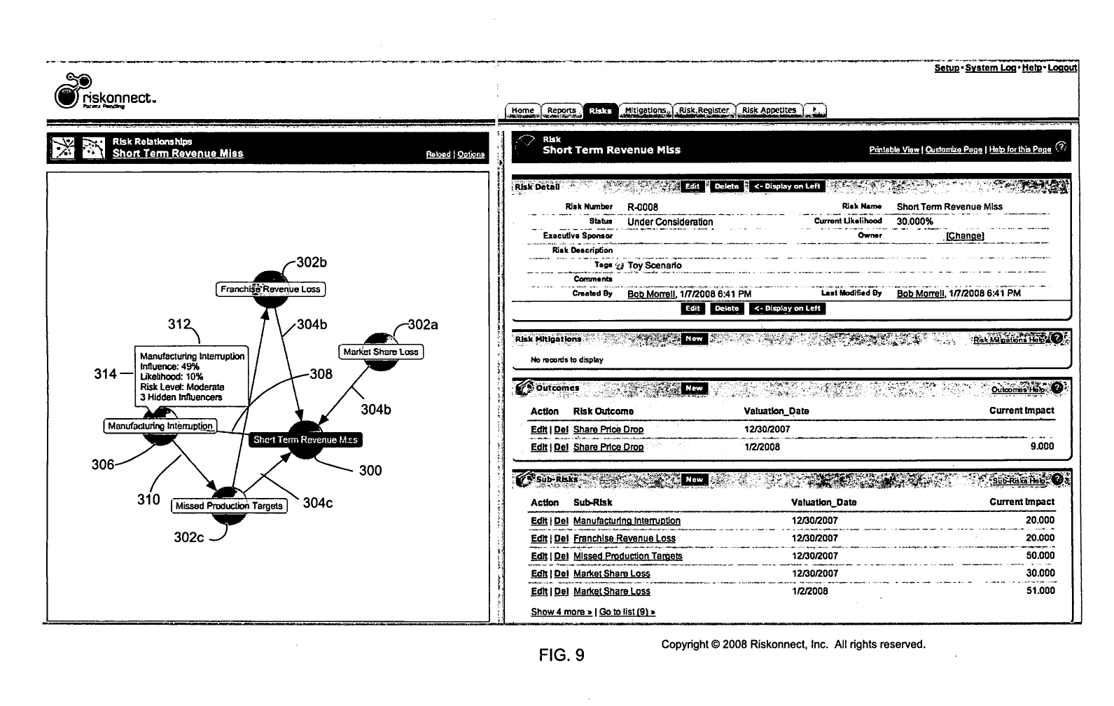

FIG. 9 illustrates an exemplary GUI graphically displaying a set of risks, the relationships interconnecting the risks within the set, and indicia representing the cumulative influence value of each risk on a display, such as display 12 (FIG. 1). Referring to FIG. 9, a risk 300 is the selected risk or risk outcome that is directly influenced by a number of risks 302 as characterized by a number of relationships 304. Another risk 306 has both a direct influence on risk 300, as characterized by relationship 308, and an indirect influence on risk 300, as characterized by an influence relationship 310 between risk 306 and risk 302c and influence relationship 304c between risk 302c and selected risk 300. Indicia 312 related to risk 306 includes a cumulative influence value 314 labeled “influence” with a value of 49%, which indicates risk 306 has a 49% cumulative influence on selected risk 300 through the direct influence of relationship 308 and the indirect relationship 310 on risk 302c. In the present embodiment, indicia 312 is activated through the use of an input device, such as mouse 16 (FIG. 1).

In another embodiment, the risks within a cumulative influence graph, such as the ones depicted by FIGS. 8 and 9, may be color-coded such that a range of percentages defines the color each risk will appear within the graph. For example, risks that are associated with cumulative influence values between 0% and 50% may appear green, risks that are associated with cumulative influence values between 50% and 75% may appear orange, and risks associated with cumulative influence values greater than 75% may appear red. It should be understood, however, that the range of percentages, the number of ranges, and the associated colors may be defined by the user or system depending on the goals and requirements of the current user or system.

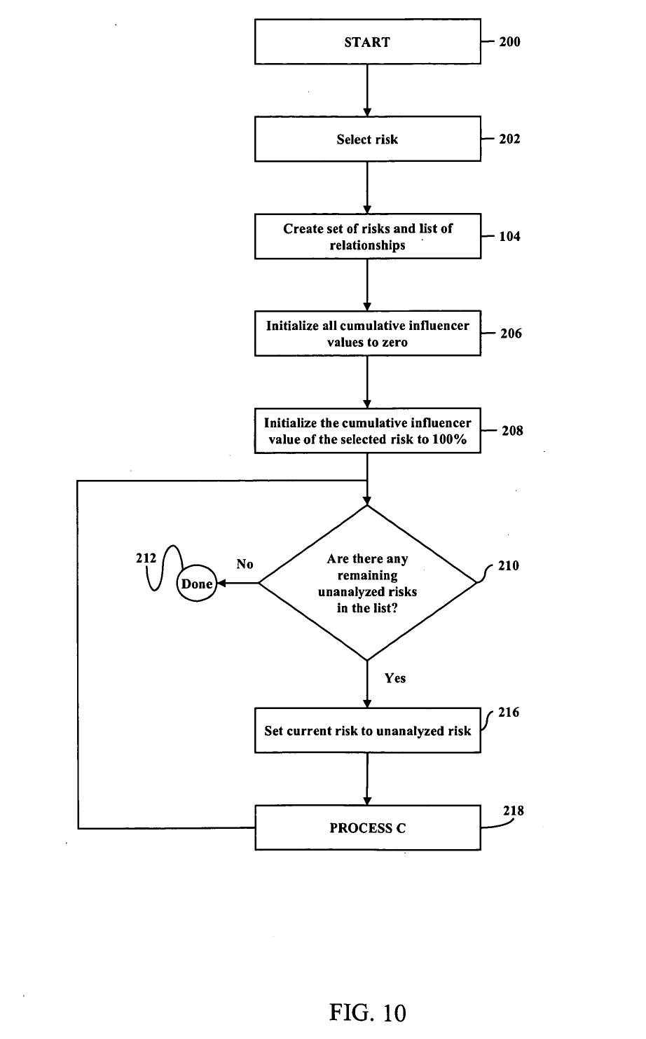

In another embodiment of the present invention, a cumulative influencer value can be assigned to each risk within a set of risks that are directly or indirectly affected by a selected risk. The cumulative influencer value indicates the overall influence the selected risk will exhibit on the other risks in the set. The process for calculating the cumulative influencer value for each risk within a given set is similar to that for calculating the cumulative influence value of each risk and is described in more detail below with reference to FIG. 10.

Referring to FIG. 10, a cumulative influencer value can be assigned to each risk within a set that is directly or indirectly influenced by the selected risk. The cumulative influencer value indicates the overall effect the selected risk will have on other risks should the selected risk occur. The process begins at 200, and a risk, of which the effect on other risks and risk outcomes is to be analyzed, is selected at block 202. At block 204, a set of risks that are influenced by the selected risk, either directly or indirectly, is created by a BFS or a DFS as described above. The set includes an identification of all the relationships among the risks within the set. At block 206, the cumulative influencer value for each risk within the set is initialized to zero. A cumulative influencer value of 100% is assigned to the selected risk at block 208, and the selected risk is marked as analyzed. It should be understood that a cumulative influencer value of 100% indicates that the risk to which the value is associated would occur if the selected risk occurs. Thus, a value of 100% is assigned to the selected risk because its occurrence would have a complete effect on itself.

Once a risk, such as the selected risk, has been assigned a cumulative influencer value, the cumulative influencer values for the risks that are influenced by the selected risk can be calculated. For the convenience of the following explanation, each risk whose cumulative influencer value has been calculated is referred to as the “valued risk,” while the risk for which the cumulative influencer value is currently being calculated is referred to as the “current risk.”

At decision block 210, the determination is made whether the risk set created at block 204 contains any unanalyzed risks. Whether a risk within the set has been marked as analyzed is described in more detail below. If the risk set does not include any more unanalyzed risks, the process is complete at block 212. If the risk set does contain at least one unanalyzed risk, however, process flow continues to block 216 where the “current risk” is set to any unanalyzed risk in the risk set. At block 218, the current risk is then provided as an “input risk” to Process C.

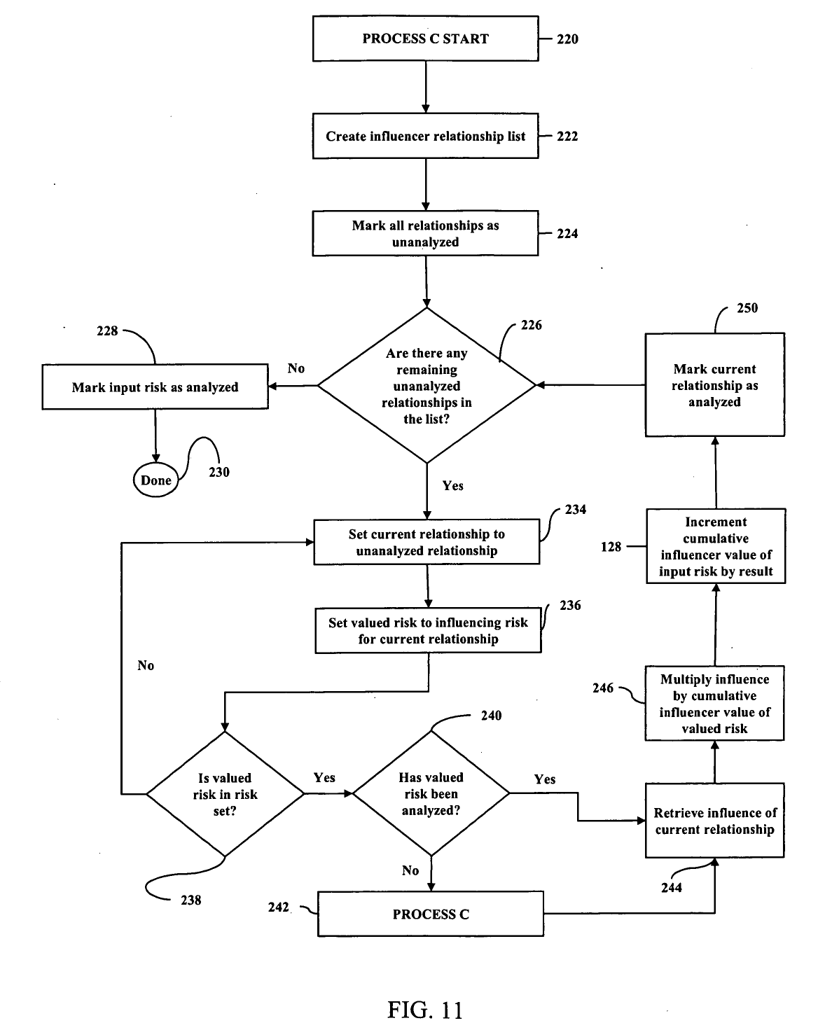

Referring to FIG. 11, Process C begins at block 220, and at block 222, a list of relationships is created from the set of risks where the input risk is influenced by another risk or risk outcome in the set. In other words, the list includes relationships where the input risk is the outcome risk in the Risk Relationship table 36 (FIG. 2) and the influencing risk is in the set. Each relationship in the list created at block 222 is marked as unanalyzed at block 224. At decision block 226, the determination is made whether there are any unanalyzed relationships in the list created at block 222. If not, process flow continues to block 228, where the input risk is marked as analyzed, and then on to block 230, where Process C terminates. In this situation, process flow returns to block 218 (FIG. 10) and on to decision block 210 where process continues as described above.

If there are any remaining unanalyzed relationships, however, process flow continues to block 234 where the “current relationship” is set to any unanalyzed relationship in the relationship list created at block 222. At block 236, the “valued risk” is set to the influencing risk of the current relationship. At decision block 238, the determination is made whether the valued risk is in the set created at block 204 (FIG. 10), meaning that the valued risk is influenced, either directly or indirectly, by the selected risk. If the valued risk is not in the set, the corresponding relationship is marked as analyzed, and process flow returns to block 234, where the current relationship is set to the next unanalyzed relationship. If the valued risk is in the set created at block 204 (FIG. 10), the determination is then made whether the valued risk has been analyzed at decision block 240. If it has not, the valued risk is then provided as an input risk to Process C at block 242. Thus, it should be understood that the described process is recursive in nature, and the subroutine referred to as “Process C” may be recursively executed. Process C for the new input risk begins at block 220 and flows as described above. Upon completion of the recursive Process C, process flow continues to block 244 and continues as described below.

If the determination is made at block 240 that the valued risk has been analyzed, process flow continues directly to block 244. The influence of the current relationship is retrieved from the set at block 244 and multiplied by the cumulative influencer value of the valued risk at block 246. The result is added to the cumulative influencer value of the input risk at block 248. At block 250, the list of relationships created at block 222 is updated to indicate the current relationship has been analyzed. Process flow then returns to decision block 226 and continues as described above.

Similar to the process described above with respect to FIGS. 6 and 7, it should be understood that the above process may yield a cumulative influencer value that is greater than 100% for a given risk, thereby indicating that the selected risk may have very a significant cumulative influence on a given risk. In the presently-described embodiment, a value greater than 100% is reduced to 100% because the selected risk generally cannot exhibit greater than a full influence on a given risk. It should be apparent, however, that a value greater than 100% can be associated with a given risk to show the significance of the cumulative influence of the selected risk on a given risk depending on the goals and requirements of the current user or system. Likewise, risks that are associated with a cumulative influencer value less than a predefined amount, such as 0% or 5% for example, may be excluded by the system at the request of the user.

Following the example described above with respect to FIGS. 10 and 11, should an epidemic occur, it may influence almost every other risk or risk outcome for a given business. Depending on the size of the influence that the epidemic exhibits on each of the risks or risk outcomes that it directly influences, a cumulative influencer value of greater than 100% may be assigned to risks that are either directly or indirectly influenced by the epidemic. This would indicate that the occurrence of the epidemic would have a very significant cumulative influence on those risks, such as the overall operation or performance of the business.

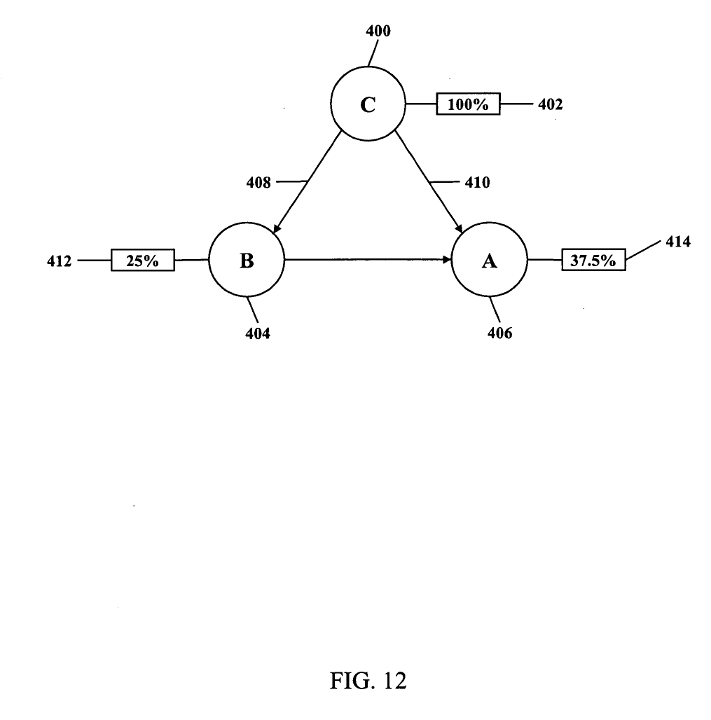

In another embodiment of the present invention, the risks within a set, the relationships interconnecting the risks, and the cumulative influencer value of each risk may be graphically displayed once the process described above with respect to FIGS. 10 and 11 has been performed for the set of risks created with respect to the selected risk. FIG. 12 depicts such a graph that is based on the data set forth above in exemplary Tables 1 and 2. Referring to FIG. 12, a node 400 is the selected risk, which is Risk C in the current example. Risk C is associated with a cumulative influencer value of 100% denoted at 402. Risk C influences Risk B (at 404) and Risk A (at 406) as indicated by relationships 408 and 410, respectively. Risk B is associated with a cumulative influencer value of 25%, denoted at 412, while Risk A is associated with a cumulative influencer value of 37.5%, denoted at 414. This indicates that the occurrence of Risk C will have a 25% influence on Risk B and a 37.5% influence on Risk A. Although FIG. 12 represents an exemplary graph in two dimensions, it should be understood that the risks within a given set may be illustrated in three dimensions.

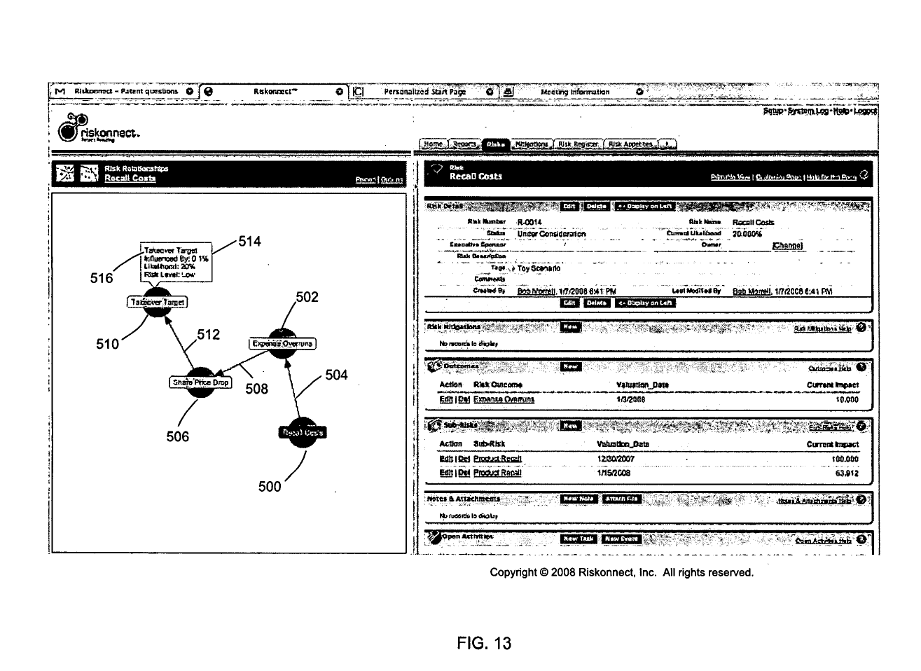

FIG. 13 illustrates an exemplary GUI graphically displaying a set of risks, the relationships interconnecting the risks within the set, and indicia representing the cumulative influencer value of each risk on a display, such as display 12 (FIG. 1). Referring to FIG. 13, a risk 500 is the selected risk or risk outcome that directly influences risk 502 as characterized by relationship 504. Risk 502 directly influences risk 506, as characterized by relationship 508, while risk 506 directly influences risk 510 as characterized by relationship 512. Indicia 514 related to risk 510 includes a cumulative influencer value 516 labeled “influenced by” with a value of 0.1%, which indicates selected risk 500 has a 0.1% indirect influence on risk 510 via relationships 504, 508, and 512. In the present embodiment, indicia 514 is activated through the use of an input device, such as mouse 16 (FIG. 1).

Similar to the explanation above with respect to FIGS. 8 and 9, the risks within a cumulative influencer graph, such as the one depicted by FIGS. 12 and 13, may be color coded such that a range of percentages defines the color that each risk will appear within the graph in yet another embodiment. It should be understood that the range of percentages, the number of ranges, and the associated colors may be defined by the user or system depending on the goals and requirements of the current user or system.

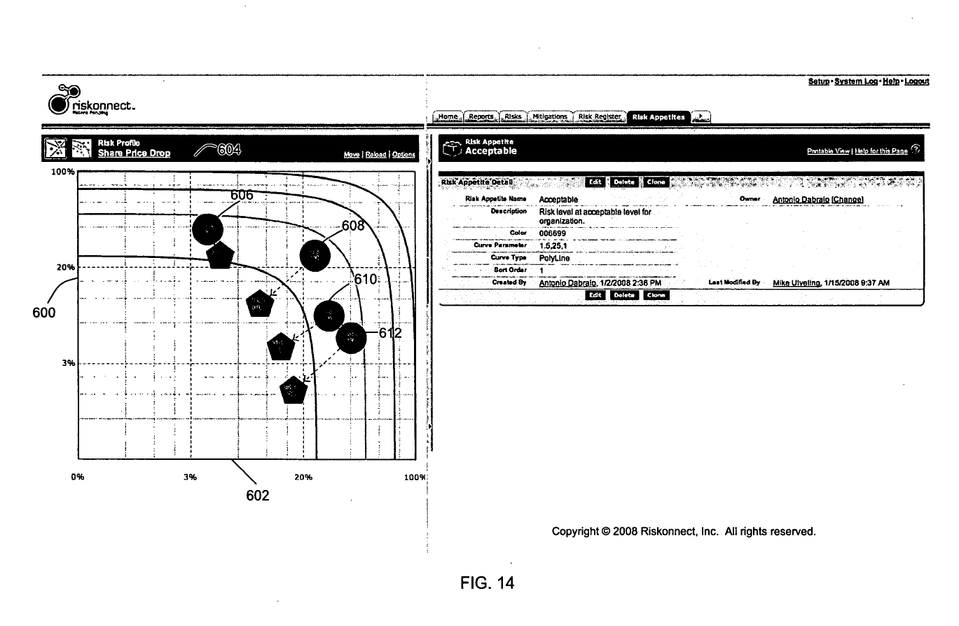

FIG. 14 illustrates an exemplary GUI graphically displaying a risk profile for a selected risk. A risk profile, such as the example set forth in FIG. 14, graphically displays the risks that directly influence the selected risk, along with the associated influences as measured by the cumulative influence value described above of the risks. Referring to FIG. 14, the y-axis 600 represents a scale of cumulative influence values, while the x-axis 602 represents a scale of annual likelihood (the frequency chosen for the present embodiment) of a risk's occurrence. A description of the selected risk or risk outcome is denoted at 604 near the top of the GUI. Risks 606, 608, 610, and 612 are graphically displayed in the GUI such that the y coordinate of each risk is defined by the risk's cumulative influence value and the x coordinate of each risk is defined by the risk's annual likelihood. It should be noted that, while the GUI in FIG. 14 illustrates the cumulative influence and annual likelihood scales as logarithmic scales, either or both scales may be configured to be linear scales.

Altering the frequency of a risk, which is stored in a risk table, such as Table 1, will affect the related graphical displays described above. Altering the influence one risk exhibits on another, which is stored in a risk relationship table, such as Table 2, will affect both the calculations performed in the processes and the related graphical displays described above. A user may alter the characteristics associated with a risk by modifying the data stored in the risk and relationship tables or by moving the risk within a graphical display by using an input device, such as mouse 16 (FIG. 1). Referring to FIG. 1, processor 20 retrieves the data stored in database 24 on computer readable media 22 and displays it on display 12, which allows the user to manipulate the data with one or more input devices, such as mouse 16 and/or a keyboard connected to computer 14. With reference to FIG. 3A, for example, a user may select Risk B (50) using mouse 16 (FIG. 1) and move the risk vertically to alter the risk's influence on selected Risk A (54).

In another embodiment, altering the frequency or influence of a risk dynamically updates any graph, display, or profile that utilizes the modified influence or frequency in a calculation. For example, vertically moving Risk B within FIG. 3A as described above modifies the influence of Risk B (50) on Risk A (54). Referring again to FIG. 1, when system 10 displays a cumulative influence graph that includes the modified risk or relationship, such as the ones shown in FIGS. 8 and 9, on display 12, processor 20 automatically updates the cumulative influence value, influence of the risk on the risk outcome, or frequency of the risk stored on computer readable media 22 in order to reflect the change made to the risk's characteristics. Additionally, when system 10 displays the relevant graph or display, processor 20 automatically updates any other risks or relationships affected by the modification to the characteristics. Thus, when the user changes the influence of Risk B on Risk A as noted above, processor 20 dynamically and automatically updates the value of the influence Risk D has on Risk A (as graphically illustrated in FIG. 8) the next time system 10 displays the cumulative influence graph shown in FIG. 8 on display 12. This process allows a user to dynamically manipulate and analyze the effect that an increase or decrease in the frequency or influence of a risk will have on other associated risks or risk outcomes. Risk assessment of the overall business or a selected risk can be performed dynamically and quickly.

In yet another embodiment, a cumulative influence graph, such as the graphical displays shown in FIGS. 5A, 5B, and 9, or a cumulative influencer graph, such as the graphical displays shown in FIGS. 12 and 13, is configured to be interactive and displayed on a computer display, such as display 12 (FIG. 1). In such an embodiment, and with reference to FIG. 1, the user is able to select a risk from the displayed graph in order to make it the selected risk. As a result, processor 20 dynamically rearranges the respective graph and recalculates the cumulative influencer values for the graph based on the newly-selected risk. For example, when the user selects Risk B from the graph shown in FIG. 3B using mouse 16, system 10 identifies Risk B as the selected risk, and processor 20 organizes the cumulative influence graph to display all risks that directly or indirectly influence Risk B, along with their respective cumulative influence values, on display 12. Similarly, the user can select Risk B from the cumulative influencer graph shown in FIG. 12 using mouse 16 in order to cause processor 20 to rearrange the graph to display all the risks that are influenced by Risk B, along with their respective cumulative influencer values, on display 12. The system may include other functionality that allows the user to manipulate the current graph, such as the ability to rotate, spin, or revolve the displayed graph or the ability to click and drag certain risks, so that the influence and relationships of the risks may be better viewed, without departing from the scope and spirit of the present invention.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

The invention claimed is:

1. A computerized method for assessing a risk outcome that is affected by other risks, the method comprising the steps of:
identifying a plurality of risks and a risk outcome;
defining a relationship hierarchy among the plurality of risks and the risk outcome, wherein all the risks of the plurality of risks directly or indirectly influence the risk outcome, comprising defining an influence of each risk on at least one other of the plurality of risks or the risk outcome; and
graphically displaying at least a portion of the relationship hierarchy, comprising graphically displaying a subset of the plurality of risks.

2. The computerized method of claim 1 further comprising graphically displaying an entire portion of the relationship hierarchy, comprising graphically displaying the plurality of risks.

3. The computerized method of claim 1 wherein the graphical display is two dimensional.

4. The computerized method of claim 1 further comprising:
calculating a cumulative influence of each risk of the subset of the plurality of risks on the risk outcome; and
graphically displaying an indicia for each risk of the subset of the plurality of risks representing the cumulative influence of the respective risk.

5. The computerized method of claim 4 wherein the indicia is a color corresponding to a predefined level associated with a range of cumulative influence.

6. The computerized method of claim 4 wherein the indicia is a numeric value corresponding to the cumulative influence.

7. The computerized method of claim 4 further comprising when the direct influence of a first risk of the subset of the plurality of risks on a second risk in that subset is changed dynamically updating the indicia for any risk of the plurality of risks that is directly or indirectly influenced by the second risk.

8. The computerized method of claim 1 further comprising:
identifying a first risk of the subset of the plurality of risks as a new risk outcome,
identifying a set of the subset of the plurality of risks that directly or indirectly influence the new risk outcome; and
graphically displaying the set of the subset of the plurality of risks.

9. The computerized method of claim 1 further comprising storing in a database the identification of the plurality of risks and the risk outcome.

10. The computerized method of claim 1 further comprising storing in a database the relationship hierarchy among the plurality of risks and the risk outcome and the influence of each risk on at least one other of the plurality of risks or the risk outcome.

11. A computerized method for assessing a risk outcome that is affected by other risks, the method comprising the steps of:
identifying a plurality of risks and a risk outcome;
defining a relationship hierarchy among the plurality of risks and the risk outcome, wherein all the risks of the plurality of risks directly or indirectly influence the risk outcome, comprising defining a direct influence of each risk on at least one other said risk or the risk outcome;
determining a cumulative influence of each first risk of the plurality of risks on the risk outcome as a function of the influences defined between the first risk and the risk outcome; and
graphically displaying a selectable group of the plurality of risks and the risk outcome, including a respective indicator for each graphically displayed risk that represents the cumulative influence of the graphically displayed risk on the risk outcome.

12. The computerized method of claim 11 further comprising:
altering a first influence that a first risk of the selectable group has on another risk of the selectable group; and
dynamically updating the cumulative influence of any risk of the selectable group directly or indirectly influenced by the first risk.

13. The computerized method of claim 11 wherein the respective indicator for each graphically displayed risk is color-coded based on a plurality of ranges of cumulative influence.

14. The computerized method of claim 11 wherein the respective indicator for each risk is a numeric value corresponding to the cumulative influence of the respective graphically displayed risk.

15. The computerized method of claim 11 further comprising:
identifying one of the graphically displayed risks as a new risk outcome;
identifying a second group of the plurality of risks that directly or indirectly influence the new risk outcome;
recalculating the cumulative influence of each first risk of the second group on the new risk outcome as a function of the influences defined between the first risk of the second group and the new risk outcome; and
dynamically updating the graphically displayed selectable group of the plurality of risks, comprising
removing any graphically displayed risk not in the second group;
adding any risk in the second group that is not in the graphically displayed selectable group to the graphically displayed selectable group; and
dynamically updating the respective indicator for each graphically displayed risk that represents the recalculated cumulative influence of the graphically displayed risk on the new risk outcome.

16. The computerized method of claim 15 wherein the step of identifying one of the graphically displayed risks as a new risk outcome is based on a selection by a user.

17. The computerized method of claim 11 wherein the respective indicator for each graphically displayed risk is displayed when the respective graphically displayed risk is selected.

18. A device for assessing a risk outcome that is affected by other risks comprising:
a computer readable medium comprising program instructions and
a processor operatively connected to the computer readable medium, wherein the processor is configured to execute the program instructions to perform a method comprising the steps of:
identifying a plurality of risks and a risk outcome;
defining a relationship hierarchy among the plurality of risks and the risk outcome, wherein all the risks of the plurality of risks directly or indirectly influence the risk outcome, comprising defining a direct influence of each risk on at least one other said risk or the risk outcome;
determining a cumulative influence of each first risk of the plurality of risks on the risk outcome as a function of the influences defined between the first risk and the risk outcome; and
graphically displaying a selectable group of the plurality of risks and the risk outcome, including a respective indicator for each graphically displayed risk that represents the cumulative influence of the graphically displayed risk on the risk outcome.

19. The device of claim 18 wherein the method performed by the processor further comprises:
altering a direct influence that a first risk of the selectable group has on another risk of the selectable group; and
dynamically updating the cumulative influence of any risk of the selectable group directly or indirectly influenced by the first risk.

20. The device of claim 18 wherein the respective indicator for each graphically displayed risk is color-coded based on a plurality of ranges of cumulative influence.

21. The device of claim 18 wherein the respective indicator for each risk is a numeric value corresponding to the cumulative influence of the respective graphically displayed risk.

22. The device of claim 18 wherein the method performed by the processor further comprises:
identifying one of the graphically displayed risks as a new risk outcome;
identifying a second group of the plurality of risks that directly or indirectly influence the new risk outcome;
recalculating the cumulative influence of each first risk of the second group on the new risk outcome as a function of the influences defined between the first risk of the second group and the new risk outcome; and
dynamically updating the graphically displayed selectable group of the plurality of risks, comprising
removing any graphically displayed risk not in the second group;
adding any risk in the second group that is not in the graphically displayed selectable group to the graphically displayed selectable group; and
dynamically updating the respective indicator for each graphically displayed risk that represents the recalculated cumulative influence of the graphically displayed risk on the new risk outcome.

23. The computerized method of claim 22 wherein the step of identifying one of the graphically displayed risks as a new risk outcome is based on a selection by a user.

24. The device of claim 18 wherein the respective indicator for each graphically displayed risk is displayed when the respective graphically displayed risk is selected.

25. The device of claim 18 wherein the computer readable medium further comprises at least one database configured to store the relationship hierarchy.

26. The device of claim 18 further comprising a display wherein the step of graphically displaying a selectable group of the plurality of risks and the risk outcome comprises graphically displaying the selectable group of the plurality of risks and the risk outcome on the display.
